(19) United States
(12) Patent Application Publication
(10) Pub. No.: US 2022/0114920 A1
(43) Pub. Date: Apr. 14, 2022

(54) Glass Temperature-Sensitive And Anti-Counterfeiting Identification Film

(71) Applicant: Wing Tak Lee Silicone Rubber Technology (Shenzhen) Co., Ltd, Shenzhen (CN)

(72) Inventor: Tak Nam LIU, Shenzhen (CN)

(21) Appl. No.: 17/325,285

(22) Filed: May 20, 2021

(30) Foreign Application Priority Data
Oct. 10, 2020 (CN) 202022246097.8

(51) Int. Cl. G09F 3/00; B32B 3/26; B32B 17/06; B32B 7/12

(52) U.S. Cl. CPC G09F 3/0294; B32B 3/263; B32B 2519/00; B32B 7/12; B32B 17/06

(57) ABSTRACT

The present application provides a glass temperature-sensitive and anti-counterfeiting identification film, which comprises a glass film, a glue layer and a protective film; wherein a partial area of an outer surface of the glass film is provided with a temperature-sensitive label.

### CROSS REFERENCE TO RELATED APPLICATION

The present application claims priority to Chinese patent application No. 202022246097.8, entitled “Glass Temperature-Sensitive And Anti-Counterfeiting Identification Film”, filed on Oct. 10, 2020, the entire content of which is incorporated herein by reference.

### TECHNICAL FIELD

The present application relates to the field of mobile phone accessories, and in particular to a glass temperature-sensitive and anti-counterfeiting identification film.

### BACKGROUND

A mobile phone film is made of glass material, and the glass film has a high requirement for transparency. Therefore, for the mobile phone film, the manufacturer's logo cannot be put on it, which affects the anti-counterfeiting performance.

### SUMMARY

The embodiments of the present application provide a glass temperature-sensitive and anti-counterfeiting identification film, which is marked with a temperature-sensitive and anti-counterfeiting label through a mobile phone film, thereby realizing an anti-counterfeiting identification and improving an anti-counterfeiting performance of the mobile phone film under the premise of ensuring transparency.

The first embodiment of the present application provides a glass temperature-sensitive and anti-counterfeiting identification film, which includes a glass film, a glue layer and a protective film; wherein a partial area of an outer surface of the glass film is provided with a temperature-sensitive label.

Preferably; the temperature-sensitive label is a logo.

Preferably, peripheral edges of the glass film have a thickness greater than that of a centre of the glass film.

Preferably, the temperature-sensitive label is located in a central area of the outer surface of the glass film.

The implementation of the embodiments of the present application has the following beneficial effects:

It can be seen that the mobile phone film provided by the present application is marked with the temperature-sensitive and anti-counterfeiting label, which will not be displayed at room temperature, but will be displayed when the temperature becomes higher, for example, when the temperature becomes higher by blowing air through the mouth, thereby realizing the anti-counterfeiting identification and improving the anti-counterfeiting performance of the mobile phone film under the premise of ensuring transparency.

### BRIEF DESCRIPTION OF THE DRAWINGS

In order to more clearly describe the technical solutions in the embodiments of the present application, the following will briefly introduce the drawings used in the description of the embodiments. Obviously, the drawings in the following description are some embodiments of the present application. For those of ordinary skill in the art, without creative work, other drawings can be obtained based on these drawings.

FIG. 1 is a schematic diagram of the structure of a glass temperature-sensitive and anti-counterfeiting identification film provided by an embodiment of the present application.

FIG. 2 is schematic diagram of the location of a temperature-sensitive and anti-counterfeiting label provided by the present application.

### DESCRIPTION OF THE EMBODIMENTS

The technical solutions in the embodiments of the present application will be described clearly and completely below with reference to the accompanying drawings in the embodiments of the present application. Obviously, the described embodiments are part of the embodiments of the present application, rather than all of the embodiments. Based on the embodiments in the present application, all other embodiments obtained by those of ordinary skill in the art without creative work shall fall within the protection scope of the present application.

The terms, such as “first”, “second”, “third” and “fourth” etc., in the specification and claims of the present application and the drawings are used to distinguish different objects, not to describe a specific order. In addition, the terms “including” and “having” and any variations thereof are intended to cover non-exclusive inclusions. For example, a process, method, system, product, or device that includes a series of steps or units is not limited to the listed steps or units, but optionally includes unlisted steps or units, or optionally also includes other steps or units inherent to these processes, methods, products or equipment.

References to “embodiments” herein means that a specific feature, structure, or characteristic described in conjunction with the embodiments may be included in at least one embodiment of the present application. The appearance of the phrase in various places in the specification does not necessarily refer to the same embodiment, nor is it an independent or alternative embodiment mutually exclusive with other embodiments. Those skilled in the art clearly and implicitly understand that the embodiments described herein can be combined with other embodiments.

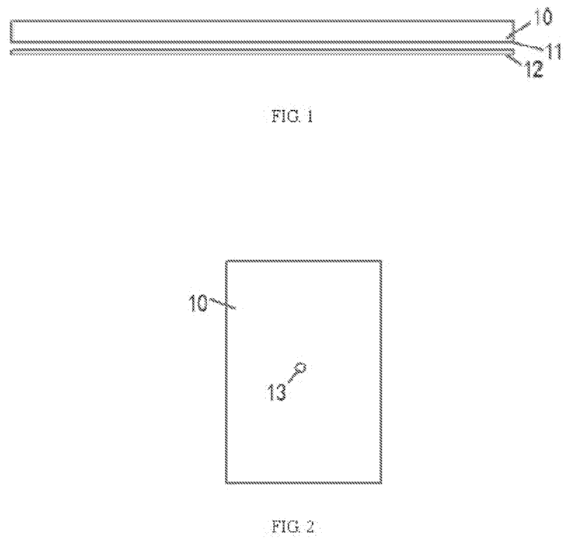

Refer to FIG. 1 and FIG. 2, FIG. 1 is a schematic diagram of the structure of a glass temperature-sensitive and anti-counterfeiting identification film provided by the present application. As shown in FIG. 1, the glass temperature-sensitive and anti-counterfeiting identification film includes a glass film 10, a glue layer 11 and a protective film 12; wherein a partial area of an outer surface of the glass film 10 is provided with a temperature-sensitive label 13.

As shown in FIG. 2, in an alternative embodiment, the above-mentioned temperature, sensitive label 13 may be provided in a central area of the outer surface of the glass film 10. It is easier for users to see the label in the central area.

The formation method of the above-mentioned temperature-sensitive label 13 may specifically include:

The temperature-sensitive label is firstly screen-printed with a transparent liquid oil, and its surface is treated with AF Coating; the transparent liquid oil is de-oiled to form the temperature-sensitive label.

In an alternative embodiment, the aforementioned temperature-sensitive label 13 may be a logo.

In an alternative embodiment, peripheral edges of the glass film 10 have a thickness greater than that of a centre of the glass film, which can be achieved by changing the mold. The arrangement peripheral edges have a thickness greater than that of the centre can enhance the edge strength of the glass film 10, and further avoid the damage of the glass film and improve the reliability of the glass film protection.

The embodiments of the application are described in detail above, and specific examples are used in the specification to illustrate the principles and implementation of the present application. The descriptions of the above embodiments are only used to help understand the methods and core ideas of the present application; at the same time, for those of ordinary skill in the art, based on the ideas of the present application, there will be changes in the specific implementation and the scope of application. In summary, the content of the present specification should not be construed as limiting, the present application.

What is claimed is:

1. A glass temperature-sensitive and anti-counterfeiting identification film, comprising:
a glass film, a glue layer and a protective film;
wherein a partial area of an outer surface of the glass film is provided with a temperature-sensitive label.

2. The glass temperature-sensitive and anti-counterfeiting identification film of claim 1, wherein the temperature-sensitive label is a logo.

3. The glass temperature-sensitive, and anti-counterfeiting identification film of claim 1, wherein peripheral, edges of the glass film have a thickness greater than that of a centre of the glass film.

4. The glass temperature-sensitive and anti-counterfeiting identification film of claim 2, wherein the temperature-sensitive label is located in a central area of the outer surface of the glass film.
